(19) United States
(12) Patent Application Publication
(10) Pub. No.: US 2008/0104609 A1
(43) Pub. Date: May 1, 2008

(54) SYSTEM AND METHOD FOR LOAD BALANCING DISTRIBUTED SIMULATIONS IN VIRTUAL ENVIRONMENTS

(76) Inventors: Bruce D. D'Amora, New Milford, CT (US); James R. Moulic, Poughkeepsie, NY (US); Ashwini K. Nanda, Mohegan Lake, NY (US)

Correspondence Address: GREENBLUM & BERNSTEIN, P.L.C., 1950 ROLAND CLARK DRIVE, RESTON, VA, 20191, US

(21) Appl. No.: 11/553,178

(22) Filed: Oct. 26, 2006

(51) Int. Cl. G06F 9/46

(52) U.S. Cl. 718/106

(57) ABSTRACT

A device comprises two or more nodes for processing a simulation of a virtual interactive environment. The two or more nodes comprising at least one component to determine workload amongst at least a first node and a second node the two or more nodes. The at least one component further delegates work to the second node when the workload on the first node exceeds a predetermined boundary, and accepts work from the second node when the workload on the second node is within the predetermined boundary.

### FIELD OF THE INVENTION

The invention relates generally to distributed interactive simulations and, more particularly, to a system and method for load balancing distributed simulations in virtual interactive environments.

### BACKGROUND OF THE INVENTION

Computer systems running virtual interactive environments (such as, for example, video games or flight simulators) may be run in client/server environments. The client and server may communicate via a computer network (such as, for example, a proprietary network, or the Internet). In such a client/server environment, the processing of the simulation of the virtual interactive environment may be performed by the server. In that case, the server may distribute processing requests to a plurality of processors through a dispatcher.

Historically, the dispatcher controls the distribution of processing among the processors according to a centralized management scheme, sometimes referred to as the “state model.” The dispatcher tracks and manages the workload of each processor, distributing processing requests approximately equally among the processors, such that unused processing capabilities and response time to the client are both minimized.

Some interactive virtual environments, though, in particular massively multi-user interactive virtual environments, have become so complex that the processing demands may exceed the capabilities of the dispatcher, such that a bottleneck forms at the dispatcher. These circumstances may have two undesirable effects. First, processing capability may be underutilized; and second, response time to the client could be varying.

Accordingly, a need has developed for overcoming the above problems.

### SUMMARY OF THE INVENTION

In a first aspect of the invention, a device comprises two or more nodes for processing a simulation of a virtual interactive environment. The two or more nodes comprising at least one component to determine workload amongst at least a first node and a second node the two or more nodes. The at least one component further delegates work to the second node when the workload on the first node exceeds a predetermined boundary, and accepts work from the second node when the workload on the second node is within the predetermined boundary.

In a second aspect of the invention, an apparatus comprising at least two nodes for processing a simulation of a virtual interactive environment comprises a module for transferring work amongst each of the nodes when workload on a node exceeds a predetermined boundary. The apparatus also includes a module for accepting work amongst at least one of the nodes when the workload is within the predetermined boundary on the at least one node.

In a third aspect of the invention, a method comprises balancing processing requests between at least two nodes. The first node of the at least two nodes determines a workload on the first node and transfers work to a second node when the workload on the first node exceeds a profiled boundary. The method further includes accepting work from the second node when the workload on the first node is within the profiled boundary.

In another aspect of the invention, a computer program product comprises a computer useable medium including a computer readable program. The computer readable program when executed on a computer causes the computer to distribute a workload among more than one node, and causes a first node to: determine workload on the first node; delegate work to a second node when the workload on the first node exceeds a predetermined threshold; and receive work from the second node when the workload on the first node is below the predetermined threshold.

### BRIEF DESCRIPTION OF DRAWINGS

FIG. 1 shows an environment for implementing an aspect of the invention;

FIG. 2 represents a block diagram of the invention (and equally a flow of processing requests according to a method of the present invention); and

FIG. 3 represents a geographical scope of a virtual interactive environment, divided into territorial zones in accordance with the invention.

### DETAILED DESCRIPTION OF EMBODIMENTS OF THE INVENTION

The invention relates to load balancing distributed simulations in virtual interactive environments. More particularly, the invention relates to highly interactive virtual worlds for online games and other distributed simulation scenarios. For example, the invention can be configured for virtual worlds typically simulated for massively multi-player online games, warfare training, and a variety of other distributed interactive simulations composed of massive amounts of object data and state that must be updated for potentially millions of users.

In embodiments, the invention is configured to distribute processing requests according to a territorial model, such that any bottlenecks that previously existed at the dispatch level, is reduced or eliminated. In embodiments, nodes are assigned to a sector or portions of a virtual interactive environment. The nodes are configured to process data and state information associated with the assigned sector or portion of the interactive environment. As objects move in/out of zones (e.g., pre-determined boundaries or geographic locations/features), the data and state information is transferred between the nodes. In one implementation, the nodes are constantly monitored for workload and the size of each zone assigned to a particular node is dynamically adjusted to balance the workload; that is, the processing of simulations within the zones may be adjusted according to workload allocations. In this schema the zones could varying in size as the simulation executes. In addition, in embodiments, the data is kept centrally, but an indexing scheme is used to transfer ownership of object data from one node to another as well as object state. Nodes may be executing programs specifically required to do performance monitoring and to determine if there exists an unbalanced system workload. In a Cell Broadband Engine (or Cell BE) implementation, it is contemplated that data, state, and behavior are all defined for each object. In this type of embodiment, code objects (e.g. SPU-lets on a Cell BE) would be moved with each object from one node to another in a cell implementation.

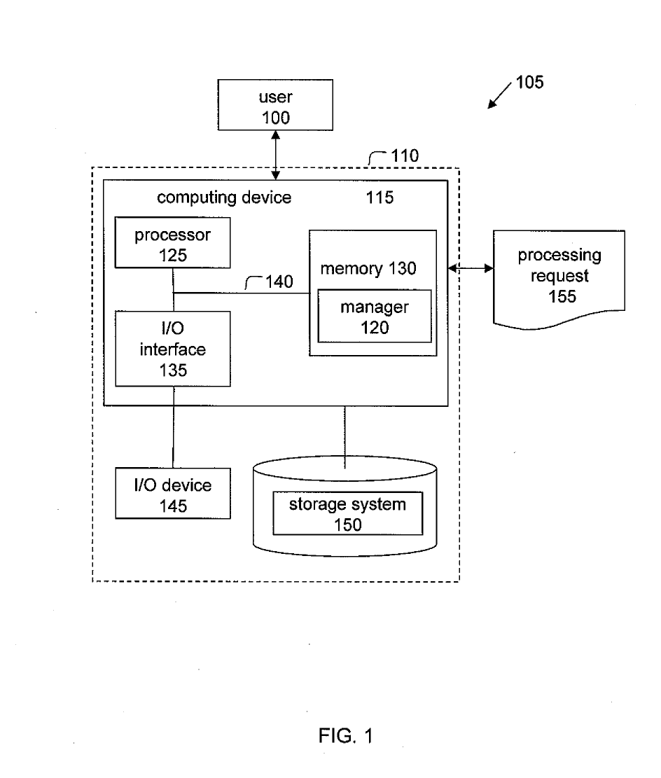

With reference to the accompanying drawings, FIG. 1 shows a user 100 using an illustrative environment 105 for managing the processes in accordance with embodiments of the invention. To this extent, the environment 105 includes a computer infrastructure 110 that can perform the processes described herein, such as, for example, simulation in a virtual interactive environment. In particular, the computer infrastructure 110 is shown including a computing device 115 that comprises a manager 120, which makes computing device 115 operable to perform at least some of the processes described herein. The computing device 115 is shown including a processor 125, a memory 130, an input/output (I/O) interface 135, and a bus 140. Further, the computing device 115 is shown in communication with an external I/O device/resource 145 and a storage system 150. As is known in the art, in general, the processor 125 executes computer program code, which is stored in memory 130 and/or storage system 150. While executing computer program code, the processor 125 can read and/or write data to/from memory 130, storage system 150, and/or I/O interface 135. The bus 140 provides a communications link between each of the components in the computing device 115. The I/O device 145 can comprise any device that enables an individual to interact with the computing device 115 or any device that enables the computing device 115 to communicate with one or more other computing devices using any type of communications link.

In any event, the computing device 115 can comprise any general purpose computing article of manufacture capable of executing computer program code installed thereon (e.g., a personal computer, server, handheld device, etc.). However, it is understood that the computing device 115 is only representative of various possible equivalent computing devices that may perform the processes described herein. To this extent, in other embodiments, the functionality provided by computing device 115 can be implemented by a computing article of manufacture that includes any combination of general and/or specific purpose hardware and/or computer program code. In each embodiment, the program code and hardware can be created using standard programming and engineering techniques, respectively.

Similarly, the computer infrastructure 110 is only illustrative of various types of computer infrastructures for implementing the invention. For example, in one embodiment, the computer infrastructure 110 comprises two or more computing devices (e.g., a client and a server, or a server cluster) that communicate over any type of communications link, such as a network, a shared memory, or the like, to perform the process described herein. Further, while performing the process described herein, one or more computing devices in the computer infrastructure 110 can communicate with one or more other computing devices external to computer infrastructure 110 using any type of communications link. In either case, the communications link can comprise any combination of various types of wired and/or wireless links; comprise any combination of one or more types of networks (e.g., the Internet, a wide area network, a local area network, a virtual private network, etc.); and/or utilize any combination of various types of transmission techniques and protocols. As discussed herein, the manager 120 enables computer infrastructure 110 to delegate or accept a processing request 155.

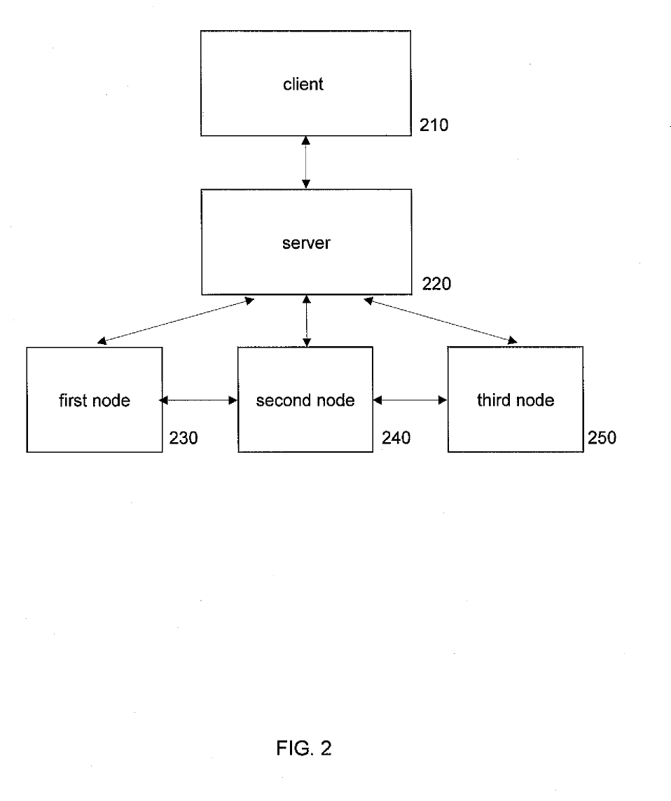

FIG. 2 represents a block diagram of the invention. FIG. 2 may equally represent a flow diagram of the steps implementing the invention. The steps of FIG. 2 may be implemented and executed by at least one component resident on a server, in a client server relationship, or on a user workstation with operative information conveyed to the user workstation. Additionally, the at least one component can take the form of an entirely hardware embodiment, an entirely software embodiment or an embodiment containing both hardware and software elements to implement the steps of the invention. In an embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium.

Referring still to FIG. 2, the method of the present invention may be implemented in a computing environment comprising a client device 210 and a server device 220, in which the client 210 is in communication with the server 220 via a network. The client 210 may comprise a local database and an event handler. According to an aspect of the invention, the method includes a “territorial model” of a virtual interactive environment, whereby a plurality of nodes 230, 240, 250 each represents some sector or portion of the virtual interactive environment (zone). The nodes 230, 240, 250 may be defined by geographic limitations or other object and/or state data more generally defined as a boundary. Although FIG. 2 shows three nodes, it should be understood by those of skill in the art that more or less than three nodes are contemplated by the invention. For example, in highly complex simulations, more than three nodes may be used in accordance with the invention.

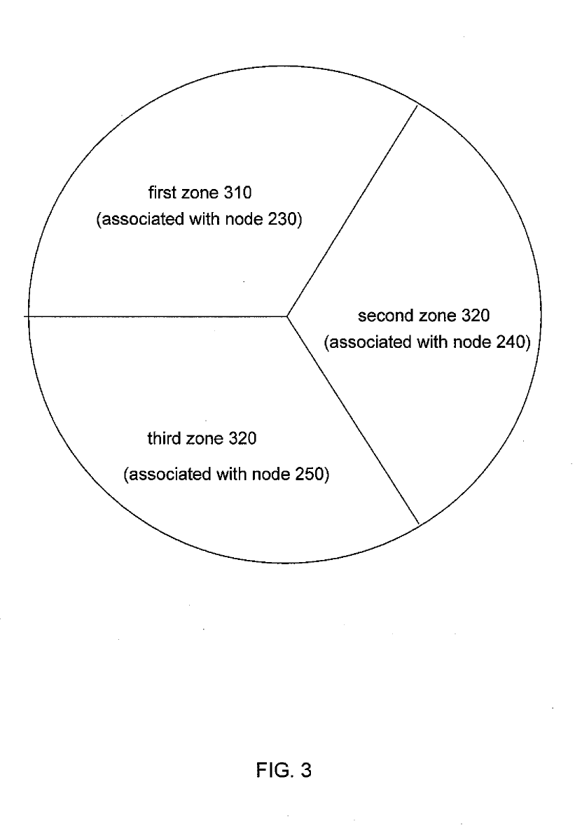

By way of example, FIG. 3 shows a mapping of geographic zones in accordance with the invention. Although FIG. 3 represents an implementation using geographic zones, it should be recognized that other boundaries are contemplated by the invention such as, for example, physical characteristics of a simulated object. As shown in FIG. 3, in a flight simulation example, the virtual interactive environment may be divided into three zones along lines separating: (1) the first zone 310, which comprises a desert airstrip; (2) the second zone 320, which comprises a mountain range; and (3) the third zone 330, which comprises a body of water. In this manner, each zone is mapped to a different work node or nodes 230, 240, 250, respectively, such that processing requests regarding objects in the first zone are processed by the first node, etc. Each node 230, 240, 250 may comprise any entity on the network, such as, for example, one or more or any combination of the following: server(s), processor(s), chip(s), general blade(s), cell blade(s), compute blade(s), and/or core(s). Each node 230, 240, 250 may also comprise processing components such as, for example, a virtual world state manager, network compression arithmetic coding, rigid body, and collisions to name a few processing components.

Upon receiving user input regarding an object in the virtual interactive environment, the client 210 may send a request for processing to the server 220. The server 220 will send the request for processing to the node that is associated with the zone in which the object exists. For example, in the flight simulation application discussed above, if the user input is regarding an object representing a plane on the airstrip, then the server 220 will send the request for processing to the first node 230, as it is associated with the first zone 310, which represents the airstrip.

According to yet another aspect of the present invention, the method includes communication between the nodes such that when a node is operating beyond its optimal maximum workload, it may delegate some processing requests to another node. Likewise, when a node is operating below its optimal minimum workload, it may accept some processing requests from another node. To this end, each node will self-monitor, for example, by measuring its frame processing or simulation rate, in known methodologies. The communication between the nodes may be linear, that is each node may communicate only with its immediate neighbors, or may be universal, that is, each node may communicate with all other nodes. Additional schemes may be employed where groups of nodes are balanced and then work is moved between groups and then each group is subsequently rebalanced. This could be a binary balancing scheme or some other technique. A more balanced state of the workload may be achieved over time as each node communicates with the other nodes and the work is distributed as zones are adjusted.

In embodiments, the territorial limits of the nodes may be dynamically readjusted. For example, in the flight simulation application discussed above, four users may be engaging in a dog fight over the mountain range, while no users are active in the airstrip. In these circumstances, the first zone 310 (originally comprising the airstrip) could expand to also cover the northern half of the mountain range. The second zone 320 (originally comprising the mountain range) could correspondingly contract to cover only the southern half of the mountain range. Depending upon the extent of the processing requests, the third zone 330 may or may not expand to accept some of the processing requests occurring over the mountain range. In any event, each node may adjust to include other territorial bounds or other conditions, depending on the loads placed on each of the nodes.

In embodiments, when an object in the simulated environment crosses a dividing line between one zone and another, one node will delegate future processing requests regarding that object to another node. Such delegation will include all data, state, and behavior information regarding the object. In this way, little kernels of code, or SPU-lets, move with each object from one node to another in a cell implementation.

According to yet another aspect of the present invention, the method includes dynamically and periodically balancing the workloads among the nodes in real time. Thus, in one example, the each of the nodes may determine workload amongst each other and delegate work amongst each other when the workload exceeds or is below a determined threshold. When the workload is above a threshold (or beyond a profiled boundary), one node may delegate work to another node. Alternatively or concurrently, a node may accept simulation processing when its workload is below a threshold (or within a profiled boundary).

Additionally, the method includes dynamically and periodically adjusting the territorial limits of each zone in real time. That is, in an embodiment, the distribution of the workload may be continually assessed and adjustments made as necessary to optimally distribute the workload, effectively minimizing unused processing capability and minimizing response time to the client. This may be, for example, accomplished by a component of the node or nodes configured to change the geographic or physical features within the virtual interactive environment according workload allocations. By way of example, when a first node is overworked, a second node may assist the first node within the same zone or geographic features.

Administrative requests or other interfacing with the network or the client 210, such as, for example, subscription, login, or other housekeeping events, may be managed by an event handler. The functionality and interoperability of the event handler with other components are well known to those of skill in the art. In one embodiment, such an event handler may reside on the server, but not within any of the compute nodes. If so, the event handler will transfer processing requests to an appropriate node after handling such administrative requests. Alternatively, such an event handler may reside within each node.

While the invention has been described in terms of embodiments, those skilled in the art will recognize that the invention can be practiced with modifications and in the spirit and scope of the appended claims.

What is claimed is:

1. A device comprising:
two or more nodes for processing a simulation of a virtual interactive environment, the two or more nodes comprising at least one component to:
determine workload amongst at least a first node and a second node the two or more nodes;
delegate work to the second node when the workload on the first node exceeds a predetermined boundary; and
accept work from the second node when the workload on the second node is within the predetermined boundary.

2. The device of claim 1, wherein each node of the two or more nodes is mapped to a zone corresponding to a portion of the virtual interactive environment, the zone being associated with the predetermined boundary.

3. The device of claim 2, wherein the zone is defined by one or more geographic features within the virtual interactive environment.

4. The device of claim 1, wherein the workload is determined by measurement of at least one of frame processing and simulation rate.

5. The device of claim 1, wherein the at least one component is configured to simultaneously communicate between the two or more nodes to determine workload allocations.

6. The device of claim 1, wherein the pre-determined boundary includes geographic features within the virtual interactive environment and the at least one component is configured to adjust the processing of simulation within the geographic features between the at least two nodes according to workload allocations.

7. An apparatus comprising at least two nodes for processing a simulation of a virtual interactive environment, wherein each node of the at least two nodes comprises:
means for transferring work amongst each of the nodes when workload on a node exceeds a predetermined boundary; and
means for accepting work amongst at least one of the nodes when the workload is within the predetermined boundary on the at least one node.

8. The apparatus of claim 7, further comprising means to dynamically and periodically balance the workload among the at least two nodes in real time.

9. The apparatus of claim 7, wherein the predetermined boundary is a mapped zone corresponding to a portion of the virtual interactive environment.

10. The apparatus of claim 9, wherein the zone is defined by one or more geographic features within the virtual interactive environment.

11. The apparatus of claim 10, further comprising means for changing the geographic features associated with each of the at least two nodes according workload allocations.

12. The apparatus of claim 11, wherein the means for changing the geographic features is performed dynamically and periodically in real time.

13. The apparatus of claim 7, wherein the workload is determined by measurement of at least one of frame processing and simulation rate.

14. The apparatus of claim 7, further comprising communication means to communicate between the at least two nodes.

15. The apparatus of claim 7, wherein the distribution of the workload is continually assessed and adjustments made to distribute the workload.

16. A method comprising balancing processing requests between at least two nodes, wherein a first node of the at least two nodes performs the steps of:
determining a workload on the first node;
transferring work to a second node when the workload on the first node exceeds a profiled boundary; and
accepting work from the second node when the workload on the first node is within the profiled boundary.

17. The method of claim 16, further comprising dynamically and periodically balancing the workload between the at least two nodes in real time.

18. The method of claim 16, wherein the profiled boundary corresponds to a geographic location of the virtual interactive environment.

19. The method of claim 16, the workload is determined by measurement of at least one of frame processing and simulation rate.

20. The method of claim 16, wherein the profiled boundary includes geographic features within the virtual interactive environment and the method includes adjusting the processing of simulation within the geographic features by the at least two nodes according to workload allocations.

21. The method of claim 18, wherein the distribution of the workload is continually assessed and adjustments made to distribute the workload amongst the at least two node.

22. A computer program product comprising a computer useable medium including a computer readable program, wherein the computer readable program when executed on a computer causes the computer to distribute a workload among more than one node, and causes a first node to:
determine workload on the first node;
delegate work to a second node when the workload on the first node exceeds a predetermined threshold; and
receive work from the second node when the workload on the first node is below the predetermined threshold.
